(19) United States
(12) Patent Application Publication
(10) Pub. No.: US 2001/0012738 A1
(43) Pub. Date: Aug. 9, 2001

(54) CLAMP FOR A BATTERY JUMPER CABLE

(76) Inventors: CYRILLE DUPERRET, CASTLE ROCK, CO (US); DEAN KALLIS, LITTLETON, CO (US); DAVID OWSLEY, AURORA, CO (US)

Correspondence Address: GLENN K BEATON, SUITE 4100, 1801 CALIFORNIA STREET, DENVER, CO, 802022641

(21) Appl. No.: 09/370,621

(22) Filed: Aug. 6, 1999

(51) Int. Cl. H01R 4/48

(52) U.S. Cl. 439/835

(57) ABSTRACT

A clamp for a battery jumper cable having jaws with offset front sides, arc-shaped edges on one or more sides of the jaw, and insulating material surrounding both jaws to prevent the jaws of one clamp from contacting the jaws of another clamp when the clamps are in the closed position. In addition, a process for making the clamp that eliminates additional assembly steps.

### FIELD OF THE INVENTION

The present invention relates to the design of a clamp used for battery jumper cables and a method for making the same.

### BACKGROUND OF THE INVENTION

Battery jumper cables are used to electrically connect a discharged battery or weaker battery with a charged battery or stronger battery. For example, they are often used to recharge a battery in a stalled automobile by connecting the discharged battery to a charged battery so that an electrical current can flow from the charged battery to the discharged battery and the stalled automobile can be started.

Battery jumper cables are usually comprised of two pairs of clamps with cables connecting the pairs of clamps. Each clamp is usually made up of two jaws that are made of conductive material, two handles that are made of or are surrounded with an insulating material, and a closing device that squeezes the jaws together so that the clamp can engage and grasp a battery terminal. The jaws are the part of the clamp that actually grasp and engage the battery terminal. They are made of conductive material so that an electrical current can flow between the charged battery and the discharged battery.

Various insulated clamps are known in the art. For example, prior art devices in this field include: Ruffa U.S. Pat. No. 5,601,452; Verge U.S. Pat. No. 5,123,861; Campbell U.S. Pat. No. 5,037,335; Lee U.S. Pat. No. 4,975,089; Bellusci U.S. Pat. No. 4,924,957; Lee U.S. Pat. No. 4,923,415; Mize U.S. Pat. No. Des. 304,928; Merio U.S. Pat. No. 4,869,688; Varatta U.S. Pat. No. 4,826,457; Mize U.S. Pat. No. 4,781,629; Woolf U.S. Pat. No. 4,620,767; Ledbefter U.S. Pat. No. 4,453,791; Johnson, III U.S. Pat. No. 4,449,772; and Pombrol U.S. Pat. No. 4,153,321.

The jaws of each clamp include an upper jaw and a lower jaw, with each jaw being comprised of a base, a front side, a left side and a right side. In addition, either the upper or lower jaw must have a means of connecting the jaw to a cable that runs between the pairs of clamps and permits electrical current to flow from the jaw on one end of the cable to the jaw on the other end of the cable. The front side, the right side and the left side of the jaw extend approximately perpendicular to and from the base. The right side and the left side of the jaw are sometimes flared outward as they extend from the base to increase the width of the jaw at the point that it engages and grasps the battery terminal. The front side, the left side and the right side of each jaw often are shaped with a jagged edge or with teeth to assist in gripping the battery terminal.

Typically, when one pair of clamps is connected to the terminals of a charged battery, it is dangerous for the jaws of the two clamps at the other end of the battery jumper cable to make contact with each other or for the jaw of one clamp to brush against or come in close contact with other metal objects. Hydrogen and oxygen gases are produced when batteries are charged and discharged. If ignited, these gases can cause an explosion. If the jaws of two clamps contact each other, the rush of the current from the charged battery may produce sparks, possibly igniting the gases. Furthermore, contact between the jaws of the clamps can result in a short, causing the charged battery to become weaker or damaged. The same result may also occur if the jaws of a clamp brush against or come in close contact with other metal objects.

In addition, the production of clamps for battery jumper cables requires the assembly of various parts, including the use of fastening devices such as screws or rivets to secure the pieces of the clamp together. Typically, the closing device, the insulating material and the jaws are each made separately and then assembled to form the clamp. The fastening device is necessary to hold parts of the clamp together. For example, the jaws are often fastened to the insulating material or handles with a screw or a rivet. Therefore, clamp assembly requires the use of additional tools to fasten the parts together and properly assemble the clamps. This also adds additional time to the clamp assembly process.

Furthermore, the jaws of the clamps are typically shaped with a straight or jagged edge. The jagged edge or teeth like pattern of the jaw has been used to help the clamp grasp the battery terminal. However, the jagged or straight edge does not maximize the surface area of the jaw that comes in contact with the battery terminal.

The present invention provides an inexpensive, simple clamp for a battery jumper cable in which the jaws of the clamp are sufficiently encased in an insulated material so that the jaws of one clamp cannot easily come into contact with the jaws of another clamp when the closing device of the clamps are in the clamped or closed position. This lessens the possibility of the jaws of the two clamps contacting each other or another piece of metal when the other two clamps are being handled or are engaging or grasping a charged battery, making it more difficult for a user to generate dangerous sparks or cause a short. The present invention also utilizes an arc shape for one or more edges of the jaw, thereby increasing the surface area of the jaw that contacts the battery terminal when the clamp engages the battery terminal and increasing the conductivity through the battery jumper cables and between the charged battery and discharged battery. Furthermore, the present invention provides a method for producing the jaws and handles of the clamp in a manner that eliminates the need for separate fastening devices and some assembly steps.

### SUMMARY OF THE INVENTION

A typical battery jumper cable consists of two pairs of clamps, each pair of clamps connected by a cable of wires so that the terminals of a charged or stronger battery can be connected to the terminals of a discharged or weaker battery in a manner that permits electrical current to flow from the charged or stronger battery through the discharged or weaker battery and back to the charged or stronger battery. The present invention is directed to features of and production methods for the clamps that are used in battery jumper cables.

A battery jumper cable is usually comprised of two pairs of clamps, one pair of clamps to be connected to the charged or stronger battery and one pair of clamps to be connected to a discharged or weaker battery, and a cable connecting the clamps. Each of the clamps for a battery jumper cable typically include a closing device which allows the clamp to engage and grasp a battery terminal, an upper and lower jaw that can be placed around a battery terminal, the upper and lower jaws being made of a conductive material (such as steel, copper plated steel or other comparable conductive material) and either the upper or the lower jaw being connected to a cable running between the pair of clamps so that an electrical current can flow from the jaws at one end of the cable to the jaws at the other end of the cable, the ends of the clamps opposite the jaws usually being made of or surrounded with an insulating material (such as thermoplastic) to permit a person to hold the clamps and manipulate the clamp without being shocked by an electrical current when the jaws of one or more clamps are touching or engaging the terminal of a charged battery.

In this invention, the edge of the front side of either the upper jaw or lower jaw is recessed and the front side of the other jaw is extended. This configuration of the front side of the upper jaw and the front side of the lower jaw allows the clamp to engage and grasp a wider variety of battery terminal configurations (such as end posts, side posts, top posts, etc.) and diameters.

In this invention the front side, the right side and the left side of the jaw are not necessarily shaped with a straight or jagged edge. Rather, the edges are shaped in other forms to increase the size of the battery terminal diameter that the clamps can engage and grasp and to increase the surface area of the jaw that comes in contact with the battery terminal. This invention has worked particularly well when the edges of one or more of the sides of the jaw are recessed in the shape of an arc instead of shaped as the jagged or straight edge. The arc shape permits the jaws to be placed on a wider variety of battery terminals and will increase the surface area of the jaw that is in contact with a circular shaped battery terminal when the jaw engages and grasps that battery terminal.

The jaws of this invention are also surrounded with an insulating material so that the jaws of the clamp cannot easily contact the jaws of another clamp when the closing device is in the clamped position. For example, this can be accomplished when the insulating material is thicker then the jaws, thereby surrounding the jaws so that no part of either jaw extends outside of the insulating material. This significantly reduces the chance of shorting the battery by touching the jaws of two clamps when the battery jumper cable is connected to a charged battery.

Like almost any type of jaw used in battery jumper cables, the jaw in this invention can be secured to a handle of a clamp by any generic assembly process such as by a screw, rivet, heat staking process or adhesive bonding. As such, these jaws can be used with traditional assembly processes.

However, these jaws can also be secured to clamp handles in a manner that eliminates the additional fastening or attachment step that is commonly used in the production of clamps for battery jumper cables. By using a molded insulating material (e.g., thermoplastic), a jaw for the clamp can be positioned in the mold before the insulating material sets in the mold. As the insulating material sets in the mold around the jaw, it sets in a manner which secures the jaw in place. This eliminates the subsequent assembly step of attaching the jaw to the insulating material by using a tool and/or fastener.

For example, plastic tools and objects can be made by using a plastic injection molding process. In this process, a cavity is formed in a mold and then injected with plastic. Once the plastic has set, the mold is removed and a plastic object in the shape of the cavity remains. If a jaw is properly placed into the cavity or mold before the plastic is injected, the plastic will set in a manner that secures the jaw in place. This can be done in a variety of ways including the use of a plastic shaped button. If a hole is placed in the base of the jaw, the plastic can be injected through the base of the jaw to form a button on the other side of the base. Once the plastic sets, the jaw will be held in place.

The two handles in this clamp are also easier to assemble in that they do not require an additional assembly step. The handles are pivotably connected about an axis between the ends of the handles. However, instead of being connected by an assembling process such as a screw or rivet, the plastic handles are shaped so that no fastener is required. Although a variety of configurations are possible, the invention has worked particularly well where one handle has two plastic buttons protruding from the pivot points on the handle and the other handle has two holes at the pivot points. The handles are molded so that the handle with the two buttons can be slipped between the handle with the two holes until the buttons engage the holes and hold the handles in place at the pivot points. The handles are then pivotably connected without the need for an additional assembly step or fastener. The handles can also be made so that the two plastic handles each have one button and one hole.

Finally, the clamp uses a leaf spring instead of a coil spring. When using a coil spring, the handles are harder to assemble because the two ends of the coil are placing pressure on each handle in a different direction. The leaf spring is a solid spring that places uniform pressure in one direction on the handle of the clamp. This makes the clamp easier to assemble.

### BRIEF DESCRIPTION OF THE DRAWINGS

FIG. 1 is a perspective view of one embodiment of this invention.

FIG. 2 is a perspective view from the opposite side of the same.

FIG. 3 is a front view of the same.

FIG. 4 is a perspective exploded view of one embodiment of this invention.

### DETAILED DESCRIPTION OF PREFERRED EMBODIMENTS

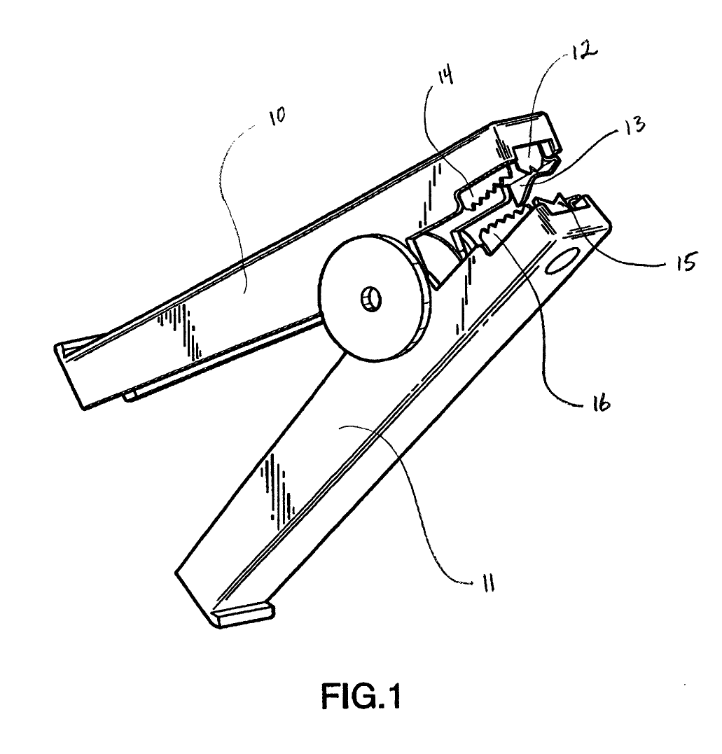

FIG. 1 shows a perspective view of one embodiment of this invention. The clamp generally has two handles that are primarily made of the insulating material: an upper handle generally indicated by numeral 10 and a lower handle generally indicated by numeral 11. A jaw is secured in one end of each handle so that the clamp can engage and grasp a battery terminal. Both the upper and lower jaw generally have a base that is partially covered by the insulating material and cannot be seen in FIG. 1. In addition, each jaw has three sides that generally extend approximately perpendicular from the base: a front side, a right side and a left side. In FIG. 1, the front side of the upper jaw is indicated by numeral 12, the right side of the upper jaw is indicated by numeral 13 and the left side of the upper jaw is indicated by numeral 14. The front side of the lower jaw is indicated by numeral 15 and the left side of the lower jaw is indicated by numeral 16.

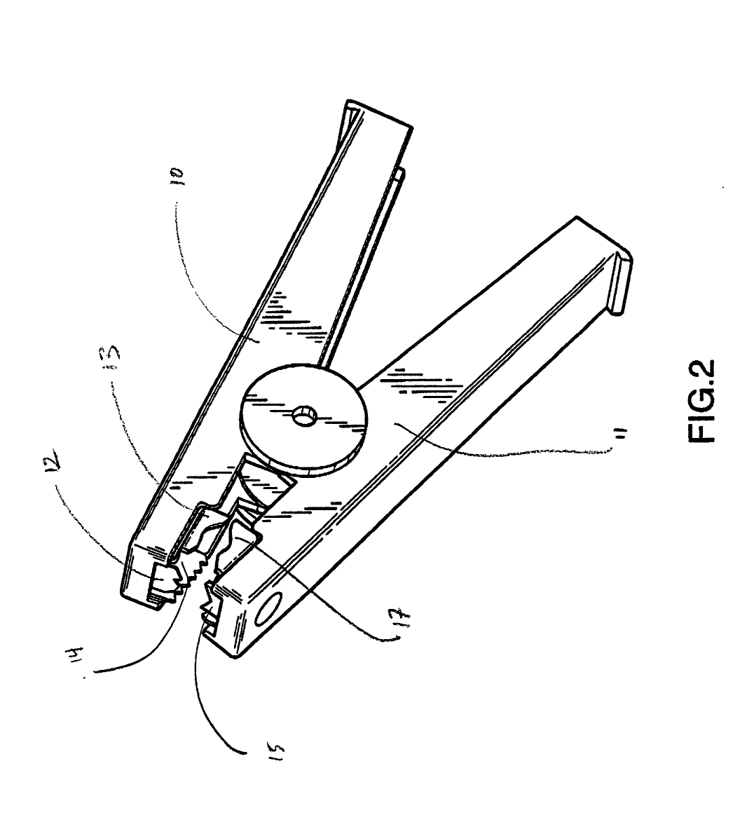

FIG. 2 is a perspective view of the same embodiment of the invention from the opposite side. Once again, the front side 12, the right side 13, and the left side 14 of the upper jaw can be seen in this figure. In addition, the front side 15, and the right side 17 of the lower jaw can also be seen.

The jaw in the upper handle and the jaw in the lower handle are together referred to as the “jaws” of the clamp because they collectively engage and grasp the battery terminal with the assistance of the closing device. Each jaw is made of a conductive material and one of the two jaws on each clamp is connected by a cable to a jaw on another clamp so that an electrical current can flow from the jaw of the first clamp to the jaw of the second clamp. The two handles are pivotably connected about an axis between the ends of the handles. A closing device, such as a torsion spring, is embedded in the handles and applies pressure on the handles in a manner that forces the jaws together. The jaws can be separated by applying pressure to the handle ends opposite the jaws and then placed around a battery terminal. When the pressure to the handle ends opposite the jaws ceases, the closing device once again forces the jaws together and the jaws engage and grasp the battery terminal.

FIGS. 1 and 2 show the shape of the edges of the sides of the jaw. The traditional jagged shape or teeth shape that is commonly used in battery jumper cables is depicted on the edge of the left side of the upper jaw 14 and the edge of the left side of the lower jaw 16. The arc shape is depicted on the edge of the right side of the upper jaw 13 and the edge of the right side of the lower jaw 17. The arc shape permits the jaws to be placed on a wider variety of battery terminals and will increase the surface area of the jaws that is in contact with a circular shaped battery terminal when the jaws are placed on that battery terminal. In addition, the left side of the upper jaw 14 and the right side of the lower jaw 16 are shaped as a plane that is approximately perpendicular to the base. In contrast, the right side of the upper jaw 13 and the right side of the lower jaw 17 are not shaped as a plane, but are designed with a flare so that the right side of the jaw is wider then the left side of the jaw. The arc shaped edge can also be used on the front side, the right side or the left side.

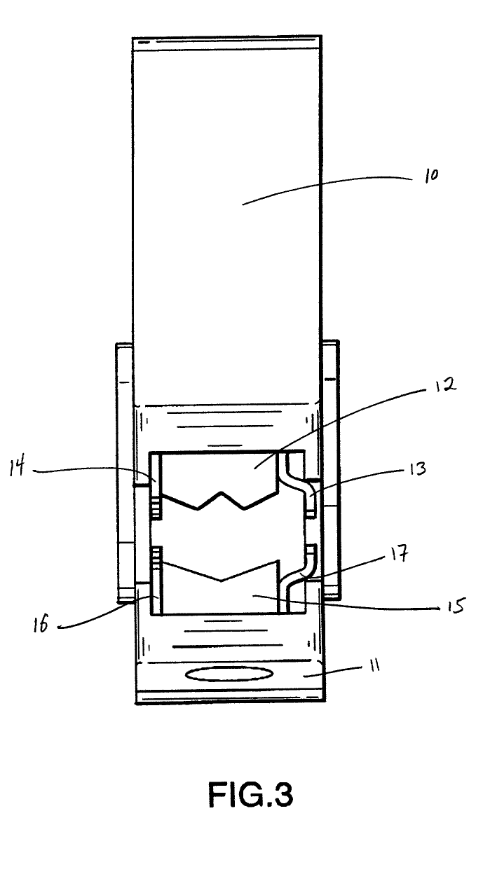

FIG. 3 shows a front view of this embodiment of the invention. This figure also shows the difference in the shape of the left and right sides of the jaws. The left side of the upper jaw 14 and the left side of the lower jaw 16 are a plane extending approximately perpendicular to the base. The right side of the upper jaw 13 and the right side of the lower jaw 17 have a flare so that the right side of the jaw is wider than the left side of this jaw.

The edge of the front side of the upper jaw 12 and the edge of the front side of the lower jaw 15 each have a shape that complements the other edge. These edges do not have the traditional jagged or teeth shape. The coordination between the two edges can be accomplished by shaping the two edges in a variety of ways so long as the edge of the two sides complement each other. As illustrated in FIG. 3, the invention has been found to work particularly well when the edge of the front side of the lower jaw 15 is recessed in the shape of a “V” at an angle of approximately 120°; the edge of the front side of the upper jaw 12 is extended in the shape of a “V” at an angle of approximately 232° with a small recession in the shape of a “V” at an angle of approximately 90° at the end of the extended edge.

In this invention, the jaws are partially surrounded with an insulating material that is wider than the jaws so that the jaws cannot contact the jaws of another clamp when the closing device is in the clamped position. The important thing is that the jaw is not flush with or extending beyond the insulating material. Rather, it is recessed within the outside edge of the insulating material. This requires the width of the insulating material surrounding the jaw to exceed the width of the jaw around the base, the front side, the right side and the left side of the jaw, thereby preventing the jaw from contacting a jaw from another clamp when both clamps are in the clamped position. This is depicted in FIG. 3 wherein the upper handle 10 and the lower handle 11, both of which are made of the insulating material, are wider than the jaws and extend beyond the right side of the upper jaw 13, the right side of the lower jaw 17, the left side of the upper jaw 14 and the left side of the lower jaw 16. The front sides of the jaws must also be recessed from the insulating materials. The invention works particularly well when the jaw is recessed approximately 0.015″ from the outside edge of the insulating material. This significantly reduces the chance of shorting a battery or creating sparks by touching the jaws of one clamp with the jaws of another clamp when the battery jumper cables are engaging a charged battery.

Like almost any type of jaw used in battery jumper cables, the jaw in this invention can be secured to a handle of a clamp by any generic assembly process such as by a screw, rivet, heat staking process or adhesive bonding. As such, the jaws can be used with traditional assembly processes.

However, these jaws can also be secured to clamp handles in a manner that eliminates the additional fastening or attaching step that is commonly used in the production of clamps for battery jumper cables. By using a molded insulating material (e.g., thermoplastic), a jaw for the clamp can be positioned in the mold before the insulating material sets in the mold. As the insulating material sets in the mold around the jaw, it sets in a manner which secures the jaw in place. This eliminates the subsequent assembly step of attaching the jaw to the insulating material by using a tool and/or fastener.

For example, plastic tools and objects can be made by using a plastic injection molding process. In this process, a cavity is formed in a mold and then injected with plastic. Once the plastic has set, the mold is removed and a plastic object in the shape of the cavity remains. If a jaw is properly placed into the cavity or mold before the plastic is injected, the plastic will set in a manner that secures the jaw in place. This can be done in a variety of ways including the use of a plastic shaped button. If a hole is placed in the base of the jaw, the plastic can be injected through the base of the jaw to form a button on the other side of the base. Once the plastic sets, the jaw will be held in place.

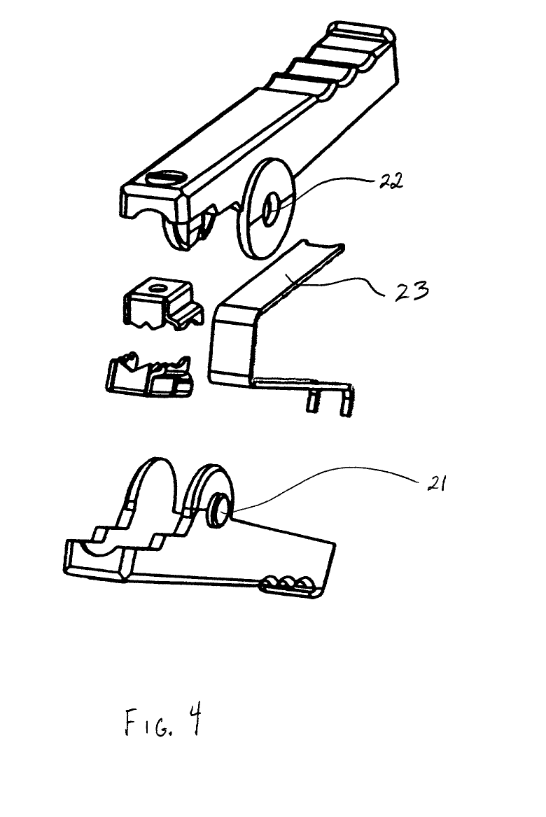

The two handles in this clamp are also easier to assemble because they do not require an additional assembly step. The handles are pivotably connected about an axis between the ends of the handles. However, instead of being connected by a fastener such as a screw or rivet, the plastic handles are shaped so that no additional fastener is required. Although a variety of configurations are possible, the invention has worked particularly well where one handle has two pivot buttons protruding at the pivot points and the other handle has two pivot holes in circular pieces of plastic at the pivot points. FIG. 4 shows one embodiment of this invention. In FIG. 4, the right pivot button is indicated by numeral 21 and the right pivot hole is indicated by numeral 22. The lower jaw also has a left pivot button and the upper jaw also has a left pivot hole. The pivot hole is in the center of the pieces of plastic and the pivot holes are slightly larger then the pivot buttons. The handles are molded so that the handle with the two pivot buttons can be slipped between the handle with the two holes until the buttons engage the holes, thereby holding the handles together at the pivot points. The handles are then pivotably connected without the need for an additional assembly step or fastening device. The handles can also be made so that each plastic handle has one pivot button and one pivot hole. The handles are then fastened in the same manner.

The closing device is often placed inside the handles. This invention has worked particularly well with a leaf spring instead of a coil spring as a closing device. When using a coil spring, the handles are harder to assemble because the two ends of the coil are placing pressure on each handle in a different direction. In contrast, the leaf spring places uniform pressure in one direction on the handle of the clamp. This makes the clamp easier to assemble. The leaf spring is indicated by numeral 23 in FIG. 4.

We claim:

1. A clamp for a battery jumper cable comprising a first and second jaw, the first and second jaw each having a base, a front side, a right side and a left side, the front side of each jaw perpendicularly extending from and to the base of the jaw, the right side of each jaw perpendicularly extending from and to the base of the jaw, the left side of each jaw perpendicularly extending from and to the base of the jaw, the edge of the right side of each jaw having an arc shape, and the first jaw having a means of connecting to a cable so that an electrical current can flow through the first jaw and the cable; a first and second plastic handle pivotably connected at a point between the ends of the first and second handle, the first and second handle each being wider then the first and second jaw; the first handle having the first jaw fastened to the end so that no part of the first jaw extends beyond the outside edge of the first handle, the second handle having the second jaw fastened to the end so that no part of the second jaw extends beyond the outside edge of the second handle; and a closing device that applies pressure on the handles so that the first and second jaws are forced together.
